(19) United States
(12) Patent Application Publication
(10) Pub. No.: US 2016/0251846 A1
(43) Pub. Date: Sep. 1, 2016

(54) MEMBRANE ANCHOR MECHANISM

(71) Applicant: IHI Corporation, Tokyo (JP)

(72) Inventors: Ryuzo KANNO, Tokyo (JP); Michitaka FURIKOMA, Tokyo (JP); Eiji KAMIYA, Tokyo (JP); Yasuhiro SHIMAMURA, Tokyo (JP)

(73) Assignee: IHI Corporation, Tokyo (JP)

(21) Appl. No.: 15/150,078

(22) Filed: May 9, 2016

Related U.S. Application Data
(63) Continuation of application No. PCT/JP2014/079065, filed on Oct. 31, 2014.

(30) Foreign Application Priority Data
Nov. 15, 2013 (JP) 2013-236943

(51) Int. Cl. E04B 1/41; F17C 13/00

(52) U.S. Cl. CPC E04B 1/40; F17C 13/001; F17C 2203/03; F17C 2205/01; F17C 2223/0161

(57) ABSTRACT

A membrane anchor mechanism which fixes a membrane provided on an inner wall surface side of a concrete wall via a heating insulating material to the concrete wall, includes a rod-shaped leg portion which is erected on the concrete wall, an anchor which is supported by the leg portion in a state of being separated from the concrete wall and is inserted into a through-hole passing through the heat insulating material and the membrane, and a pressing part which is fixed to the anchor through the through-hole and presses the membrane.

This application is a continuation application based on a PCT Patent Application No. PCT/JP2014/079065, filed on Oct. 31, 2014, whose priority is claimed on Japanese Patent Application No. 2013-236943, filed on Nov. 15, 2013. The contents of both the PCT Application and the Japanese Application are incorporated herein by reference.

### TECHNICAL FIELD

The present embodiments described herein relate to a membrane anchor mechanism.

### BACKGROUND

In the related art, in a membrane type cryogenic tank including a membrane in which a plurality of membrane panels are welded, in order to maintain a shape of a thin membrane having low stiffness, a configuration which is supported to be pressed to a concrete wall via a heat insulating material by a membrane anchor mechanism is used (for example, refer to Japanese Examined Patent Application, Second Publication No. S63-23440). As the membrane type cryogenic tank, tanks having various shapes are used, and for example, a tank which is formed to have a square corner portion, a cylindrical corner portion, or the like is also used widely. In Japanese Unexamined Patent Application, First Publication No. 2009-79736, a membrane anchor mechanism which supports a membrane panel (corner membrane panel) installed in a corner portion of a cryogenic tank is disclosed. The membrane anchor mechanism disclosed in Japanese Unexamined Patent Application, First Publication No. 2009-79736 is installed at a boundary portion of a haunch structural portion provided on a corner portion, and supports an edge portion of the corner membrane panel.

### SUMMARY

However, the above-described haunch structure is not necessarily provided on all cryogenic tanks having the corner portion. Accordingly, the membrane anchor mechanism disclosed in Japanese Unexamined Patent Application, First Publication No. 2009-79736 cannot be adopted with respect to all cryogenic tanks. Moreover, in the membrane anchor mechanism in which the support location is limited to the edge portion of the corner membrane panel, for example, disposition in which a center of the membrane panel is pressed cannot be performed.

Moreover, when a gap is generated between the membrane panel and the concrete wall, cold insulation performance of the cryogenic tank is decreased. Particularly, in the location at which the membrane anchor mechanism is installed, since the above-described gap is easily generated, preferably, the membrane anchor mechanism is configured so that the heat insulating material is disposed even in the location at which the membrane anchor mechanism is installed.

The present disclosure is made in consideration of the above-described problems, and an object thereof is to provide a membrane anchor mechanism which can support the corner membrane panel regardless of the presence or absence of the haunch structure, can press a location which is not limited to the edge portion of the corner membrane panel, and can easily dispose the heat insulating material in the periphery.

The present disclosure adopts the following configurations as means for solving the above-described problems.

According to a first aspect of the present disclosure, there is provided a membrane anchor mechanism which fixes a metal membrane provided on an inner wall surface side of a concrete wall via a heating insulating material to the concrete wall in a cryogenic tank, including: a rod-shaped leg portion which is erected on the concrete wall; an anchor which is supported by the leg portion in a state of being separated from the concrete wall and is inserted into a through-hole passing through the heat insulating material and the membrane; and a pressing part which is fixed to the anchor exposed through the through-hole and presses the membrane.

According to the present disclosure, the anchor is attached to the rod-shaped leg portion which is erected on the concrete wall. In this way, the leg portion and the anchor are formed to be separated, and thus, it is possible to easily change an attachment posture of the anchor with respect to the leg portion. Accordingly, even when the through-hole passing through the heat insulating material and the membrane is provided at any position, the attachment posture between the leg portion and the anchor is adopted according to a formation position of the through-hole, and thus, it is possible to easily dispose the anchor at a position at which the anchor can be inserted into the through-hole. The pressing part is fixed to the anchor which is inserted into the through-hole and the membrane is pressed by the pressing part, and thus, according to the present disclosure, it is possible to press an arbitrary location of the membrane by arbitrarily setting the position of the through-hole. In addition, since the leg portion can be erected at any location of the concrete wall, it is possible to install the membrane anchor mechanism regardless of whether or not a haunch structure is provided on the concrete wall. In addition, according to the present disclosure, the anchor is supported by the rod-shaped leg portion, and thus, a large space is formed between the anchor and the concrete wall. Accordingly, it is possible to easily dispose the heat insulating material in the space, and it is possible to easily dispose the heat insulating material around the membrane anchor mechanism.

### BRIEF DESCRIPTION OF THE DRAWINGS

FIG. 1 is a cross-sectional perspective view showing a cryogenic tank which includes a three-surface corner membrane anchor mechanism and a two-surface corner membrane anchor mechanism according to an embodiment of the present disclosure.

FIG. 2 is a cross-sectional view showing a three-surface corner portion including a three-surface corner membrane anchor mechanism according to the embodiment of the present disclosure.

FIG. 3 is a perspective view showing the three-surface corner membrane anchor mechanism according to the embodiment of the present disclosure in which a pressing part of the three-surface corner membrane anchor mechanism is removed and a cold insulating material layer is omitted.

FIG. 4A is a plan view which shows the three-surface corner membrane anchor mechanism according to the embodiment of the present disclosure in which a leg portion and the pressing part are removed when viewed in a direction along an axis of an anchor.

FIG. 4B is a side view when the three-surface corner membrane anchor mechanism shown in FIG. 4A is viewed in a direction orthogonal to the direction along the axis of the anchor.

FIG. 4C is a view when the three-surface corner membrane anchor mechanism shown in FIG. 4B is viewed from arrow A.

FIG. 5A is a plan view showing the pressing part of the three-surface corner membrane anchor mechanism according to the embodiment of the present disclosure.

FIG. 5B is a side view showing the pressing part shown in FIG. 5A.

FIG. 6 is a cross-sectional view showing a two-surface corner portion including a two-surface corner membrane anchor mechanism according to the embodiment of the present disclosure.

FIG. 7A is a perspective view showing an assembly process of the cryogenic tank including the three-surface corner membrane anchor mechanism according to the embodiment of the present disclosure.

FIG. 7B is a perspective view showing the assembly process of the cryogenic tank including the three-surface corner membrane anchor mechanism according to the embodiment of the present disclosure.

FIG. 7C is a perspective view showing the assembly process of the cryogenic tank including the three-surface corner membrane anchor mechanism according to the embodiment of the present disclosure.

FIG. 8A is a perspective view showing the assembly process of the cryogenic tank including the three-surface corner membrane anchor mechanism according to the embodiment of the present disclosure.

FIG. 8B is a perspective view showing the assembly process of the cryogenic tank including the three-surface corner membrane anchor mechanism according to the embodiment of the present disclosure.

FIG. 8C is a perspective view showing the assembly process of the cryogenic tank including the three-surface corner membrane anchor mechanism according to the embodiment of the present disclosure.

### DETAILED DESCRIPTION OF THE DISCLOSURE

Hereinafter, an embodiment of a membrane anchor mechanism according to the present disclosure will be described with reference to the drawings. Moreover, in the following drawings, in order to allow each member to be a recognizable size, the scale of each member is appropriately changed.

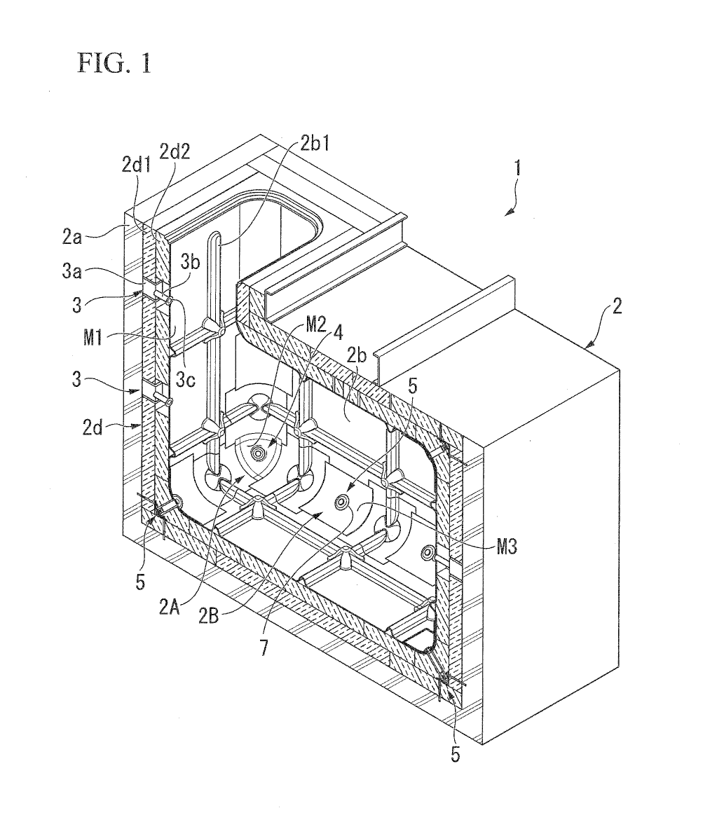

FIG. 1 is a cross-sectional perspective view showing a cryogenic tank 1. The cryogenic tank 1 includes a container main body 2, a plane membrane anchor mechanism 3, and a three-surface corner membrane anchor mechanism 4 and a two-surface corner membrane anchor mechanism 5 according to an embodiment of the present disclosure.

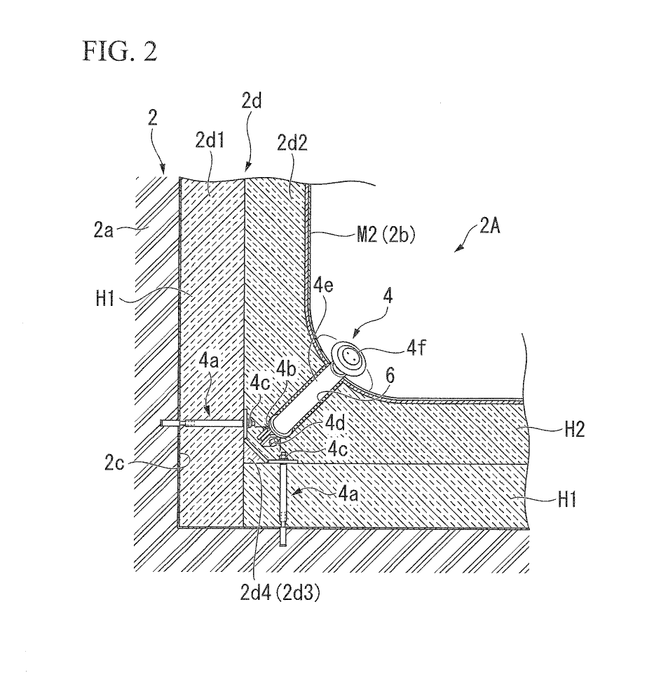

The container main body 2 is a rectangular container which includes a concrete wall 2a forming an outer tank, a membrane 2b forming an inner tank, a vapor barrier 2c (refer to FIG. 2) stuck to an inner wall surface of the concrete wall 2a, and a cold insulating material layer 2d installed between the vapor barrier 2c and the membrane 2b.

The concrete wall 2a is a wall portion formed of concrete which forms an outer shell of the container main body 2 and a strength member which supports the membrane 2b or the like. The membrane 2b is a portion which directly comes into contact with a cryogenic liquid (for example, liquefied argon) stored in an inner portion of the tank, and is installed on the inner wall surface side of the concrete wall 2a via the cold insulting material layer 2d. A corrugation 2b1 which vertically and horizontally extends in a lattice shape and absorbs thermal deformation of the membrane 2b is provided on the membrane 2b. For example, the membrane 2b is formed by welding a sheet shaped membrane panel which is formed of stainless steel and has a thickness of several millimeters.

Since the container main body 2 is formed in a rectangular shape, the container main body 2 includes a corner portion (hereinafter, referred to as a three-surface corner portion 2A) formed at a location at which three surfaces (for example, two side wall surfaces and a bottom surface, or two side wall surfaces and a top surface) are collected, and a corner portion(hereinafter, referred to as a two-surface corner portion 2B) formed at a location at which two surfaces (for example, the side wall surface and the bottom surface, the side wall surfaces, or the side wall surface and the top surface) are collected. The membrane panel which is disposed on the corner portions is curved according to the shapes of the corner portions. Hereinafter, the membrane panel on a plane which is disposed on a region other than the corner portions is referred to as a plane membrane panel M1, the membrane panel which is disposed on the three-surface corner portion 2A is referred to as a three-surface corner membrane panel M2 (corner membrane panel), and the membrane panel which is disposed on the two-surface corner portion 2B is referred to as a two-surface corner membrane panel M3.

The vapor barrier 2c is a metal sheet member which is stuck to the entire region of the inner wall surface of the concrete wall 2a. The vapor barrier 2c blocks water or the like passing through the concrete wall 2a and improve airtightness of the container main body 2.

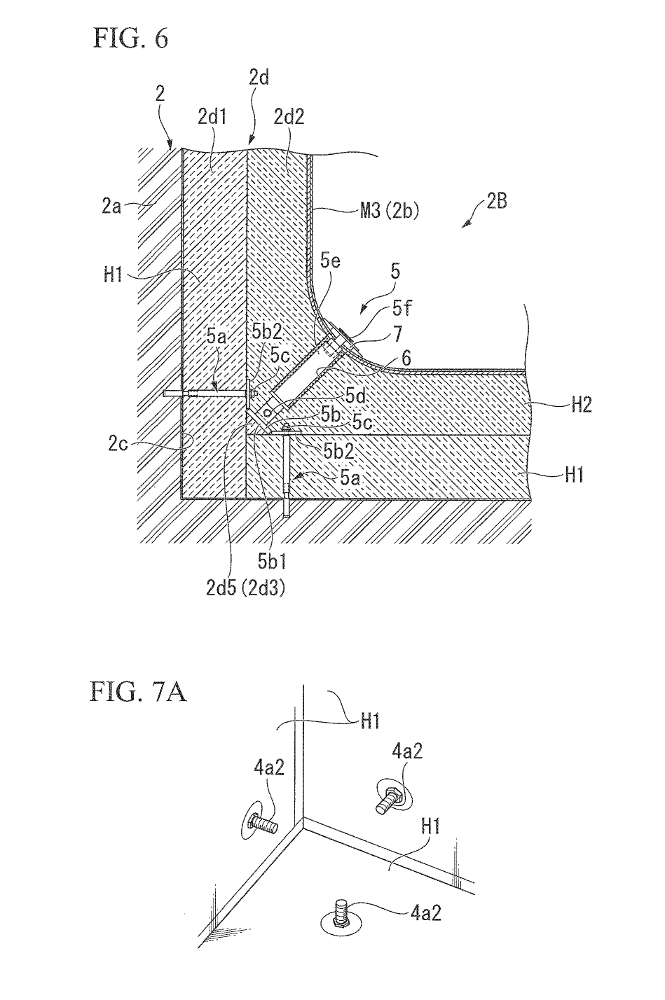

The cold insulating material layer 2d includes an outer layer portion 2d1, an inner layer portion 2d2, and a filling portion 2d3 (refer to FIG. 2 or the like). The outer layer portion 2d1 is a layer which is formed on the concrete wall 2a side of the cold insulating material layer 2d, and is formed by laying cold insulating panels H1 having the same thickness without a gap. The inner layer portion 2d2 is a layer which is formed on the membrane 2b side of the cold insulating material layer 2d, and is formed by laying cold insulating panels H2 having the same thickness without a gap. The filling portion 2d3 is a portion which is filled with respect to a gap generated when the outer layer portion 2d1 and the inner layer portion 2d2 are laid, and has a shape coincident with the shape of the installed gap. For example, as the filling portion 2d3, a filling portion (hereinafter, referred to as a filling portion for three-surface corner portion 2d4) which is filled in a gap (refer to FIG. 2) formed between a base portion 4b and an outer layer portion 2d1 of the three-surface corner-membrane anchor mechanism 4 described below, or a filling portion (hereinafter, referred to as a filling portion for two-surface corner portion 2d5) which is filled in a gap (refer to FIG. 6) formed between a base portion 5b and an outer layer portion 2d1 of the two-surface corner membrane anchor mechanism 5 described below is installed.

For example, the cold insulating material layer 2d is formed of Poly Urethane Foam (PUF), and the gap between the membrane 2b and the concrete wall 2a to which the vapor barrier 2c is stuck is filled with the cold insulating layer.

A through-hole 6 which is disposed at a center position in the thermal deformation part of each membrane panel is provided on the membrane 2b and the cold insulating material layer 2d. An anchor 3b of the plane membrane anchor mechanism 3, an anchor 4e of the three-surface corner membrane anchor mechanism 4, or an anchor 5e of the two-surface corner membrane anchor mechanism 5 is inserted into the through-hole 6.

The plane membrane anchor mechanism 3 includes a base 3a which is provided on the inner wall surface of the concrete wall 2a via the vapor barrier 2c, the anchor 3b which is fixed to the base 3a and is inserted into the through-hole 6, and a pressing part 3c which is fixed to the anchor 3b exposed from the through-hole 6 and presses the plane membrane panel M1 from the inner portion side of the container main body 2 toward the concrete wall 2a.

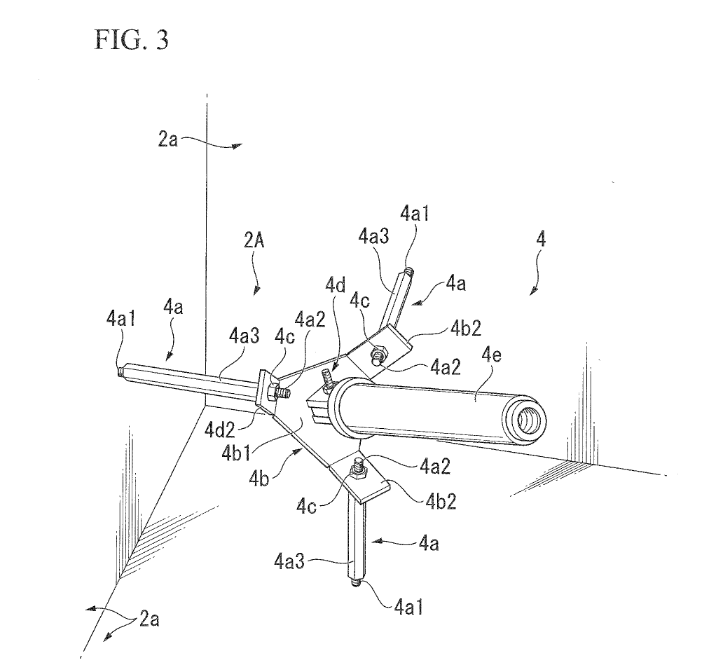

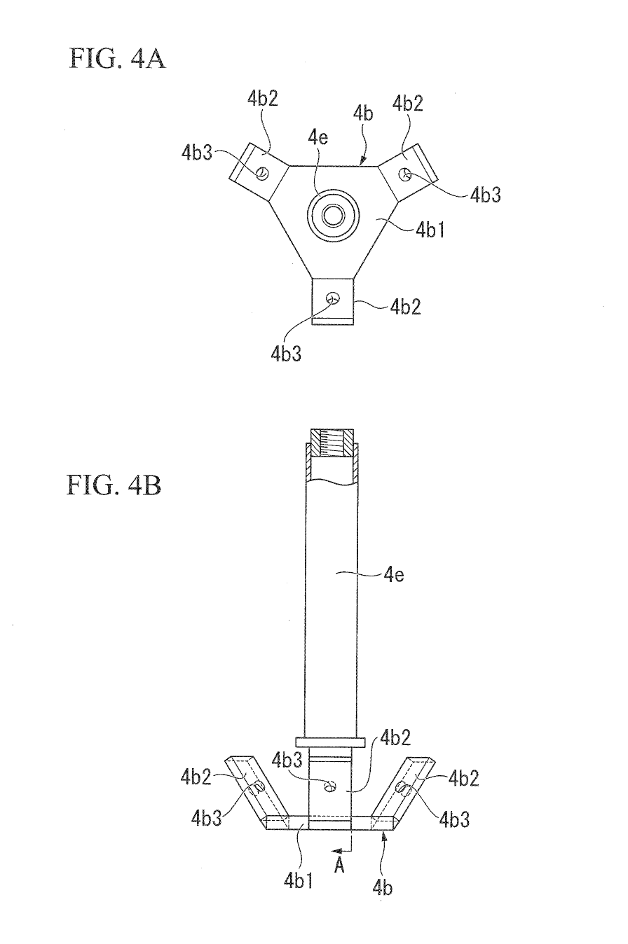

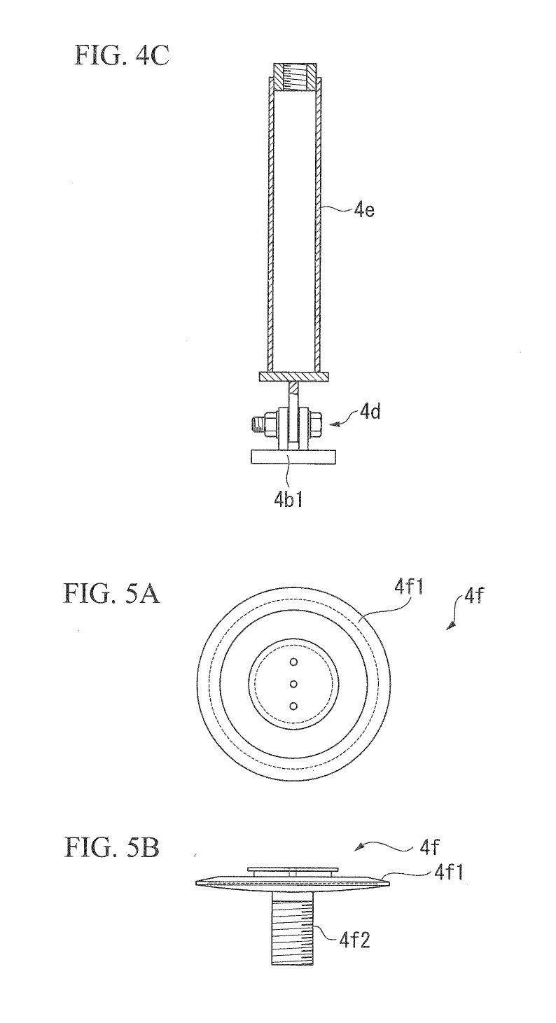

FIG. 2 is a cross-sectional view showing the three-surface corner portion 2A including the three-surface corner membrane anchor mechanism 4. Moreover, FIG. 3 is a perspective view showing the three-surface corner membrane anchor mechanism 4 in which the pressing part 3c of the three-surface corner membrane anchor mechanism 4 is removed and the cold insulating material layer 2d is omitted. FIGS. 4A to 4C are views showing the three-surface corner membrane anchor mechanism 4 in which a leg portion 4a and a pressing part 4f are removed, of which FIG. 4A is a plan view when viewed in a direction along an axis of the anchor 4e, FIG. 4B is a side view when viewed in a direction orthogonal to the direction along the axis of the anchor 4e, and FIG. 4C is a view when is viewed from arrow A of FIG. 4B.

As shown in the drawings, the three-surface corner membrane anchor mechanism 4 is provided on the three-surface corner portion 2A, and includes a leg portion 4a which is provided on each of the three surfaces forming the three-surface corner portion 2A, a base portion 4b, a nut 4c, a joint 4d, the anchor 4e, and the pressing part 4f.

The leg portion 4a is a rod-shaped member which extends in the direction perpendicular to the inner wall surface of the concrete wall 2a, and is erected on the concrete wall 2a via the vapor barrier 2c. The leg portion 4a includes a first stud bolt 4a1 which is formed on one end portion of the concrete wall 2a side, a second stud bolt 4a2 which is formed on one end portion of the base portion 4b side, and a long nut 4a3 which forms a center portion of the leg portion. A length of the leg portion 4a except for the second stud bolt 4a2 is approximately the same as the thickness in the outer layer portion 2d1 of the cold insulating material layer 2d.

One end side of the first stud bolt 4a1 is embedded in the concrete wall 2a, screw grooves are formed on the other end side, the other end is attached to protrude to the inner portion side of the container main body 2 from the vapor barrier 2c, and the first stud bolt is welded to the vapor barrier 2c. In the first stud bolt 4a1, the one end side on which the screw grooves are formed is screwed to the end portions of the long nut 4a3. In second stud bolt 4a2, screw grooves are formed on both end sides, and the second stud bolt is screwed to the end portion opposite to the end portion to which the first stud bolt 4a1 of the long nut 4a3 is screwed, and is attached to protrude to the inner portion side of the container main body 2 from the base portion 4b through the through-hole 4b3 of the base portion 4b described below. In the long nut 4a3, the first stud bolt 4a1 is screwed to the one end side, the second stud bolt 4a2 is screwed to the other end side, and the long nut connects the first stud bolt 4a1 and the second stud bolt 4a2.

In this way, the leg portion 4a in the present embodiment includes the stud bolts (first stud bolt 4a1 and second stud bolt 4a2) provided on both ends, and the long nut 4a3 to which the stud bolts are screwed.

The base portion 4b is a portion to which three leg portions 4a or the anchor 4e is attached, and is provided at a position at which the second stud bolts 4a2 of three leg portions 4a approach one another. The base portion 4b includes a center plate 4b1 on which the anchor 4e is installed via the joint 4d, and three leg portion connection plates 4b2 which are provided on edge portions of the center plate 4b1 and to which the leg portions 4a are connected. Each leg portion connection plate 4b2 is attached to the center plate 4b1 at an angle formed to oppose each surface of the concrete wall 2a forming the three-surface corner portion 2A. The leg portion connection plate 4b2 is disposed at a position at which the outer layer portion 2d1 abuts the surface of the inner layer portion 2d2 side in the above-described cold insulating material layer 2d. Moreover, the through-hole 4b3 is provided on the leg portion connection plate 4b2. The second stud bolt 4a2 of the leg portion 4a passes through the through-hole 4b3 and protrudes to the side on which the anchor 4e is installed.

The nut 4c is screwed to the second stud bolt 4a2 which protrudes from the through-hole 4b3 of the leg portion connection plate 4b2 to the anchor 4e side, and the nut abuts the surface of the anchor 4e side of the leg portion connection plate 4b2 via a washer. The nuts 4c screwed to the second stud bolts 4a2 of the leg portions 4a press the base portion 4b in different directions, and thus, the base portion 4b is fixed.

The joint 4d is attached to the center plate 4b1 of the base portion 4b and rotatably supports the anchor 4e. The joint 4d is configured to include a bolt which is in a horizontal direction orthogonal to the extension direction of the anchor 4e as an axial direction, and a nut which is screwed to the bolt and rotatably interposes the anchor 4e along with the bolt. Since the anchor 4e is supported by the joint 4d, the anchor 4e can rotate about the horizontal direction orthogonal to the extension direction of the anchor 4e.

The anchor 4e is a cylindrical member which is long in an axial direction thereof, and screw grooves for attaching the pressing part 4f are formed on the inner wall surface of the tip portion of the anchor. In the anchor 4e, the base portion of the anchor is attached to the center plate 4b1 of the base portion 4b via the joint 4d, and the tip of the anchor to which the pressing part 4f is fixed is inserted into the through-hole 6 to be exposed toward the inside of the container main body 2. The length of the anchor 4e is approximately the same as the thickness of the inner layer portion 2d2 of the cold insulating material layer 2d. The anchor 4e is supported by the base portion 4b, and thus, the anchor is supported in the state being separated from the concrete wall 2a.

FIGS. 5A and 5B are views showing the pressing part 4f, of which FIG. 5A is a plan view of the pressing part, and FIG. 5B is a side view of the pressing part. As shown in FIGS. 4A and 4B, the pressing part 4f includes a disk-shaped main body 4f l and a shaft portion 4f2 which is integrated with the main body 4f1. In the main body 4f1, one side surface is formed in a partial shape of a spherical surface matching with the surface shape of the three-surface corner membrane panel M2, and the one side surface abuts the three-surface corner membrane panel M2 from the inner portion side of the container main body 2. The shaft portion 4f2 is provided on the center portion of the main body 4f l, and is a columnar portion in which screw grooves are formed on the circumferential surface thereof. The shaft portion 4f2 is screwed to the anchor 4e. The shaft portion 4f2 is screwed to the anchor 4e to fasten the pressing part 4f, and thus, the main body 4f1 presses the three-surface corner membrane panel M2 toward the concrete wall 2a, and the three-surface corner membrane panel M2 is fixed to the concrete wall 2a. In addition, the edge portion of the main body 4f1 of the pressing part 4f is fixed to the three-surface corner membrane panel M2 by welding.

FIG. 6 is a cross-sectional view showing the two-surface corner portion 2B including the two-surface corner membrane anchor mechanism 5. The two-surface corner membrane anchor mechanism 5 has the configuration similar to that of the three-surface corner membrane anchor mechanism 4. Accordingly, here, differences between the three-surface corner membrane anchor mechanism 4 and the two-surface corner membrane anchor mechanism 5 will be mainly described. The above-described three-surface corner membrane anchor mechanism 4 is installed in the three-surface corner portion 2A at which three surfaces are collected, and thus, the three-surface corner membrane anchor mechanism 4 includes a total of three leg portions 4a which are erected on the surfaces forming the three-surface corner portion 2A. On the other hand, the two-surface corner membrane anchor mechanism 5 is installed in the two-surface corner portion 2B at which two surfaces are collected, and thus, the two-surface corner membrane anchor mechanism 5 includes only two leg portions 5a.

The base portion 5b corresponds to the base portion 4b of the three-surface corner membrane anchor mechanism 4. However, since the two-surface corner membrane anchor mechanism 5 includes only two leg portions 5a, in the base portion 5b, only two leg portion connection plates 5b2 (corresponding to the leg portion connection plate 4b2) are provided with respect to a center plate 5b1 (corresponding to the center plate 4b1) on which a joint 5d is installed.

A nut 5c corresponds to the nut 4c of the three-surface corner membrane anchor mechanism 4, the joint 5d corresponds to the joint 4d of the three-surface corner membrane anchor mechanism 4, and the anchor 5e corresponds to the anchor 4e of the three-surface corner membrane anchor mechanism 4.

A pressing part 5f corresponds to the pressing part 4f of the three-surface corner membrane anchor mechanism 4. However, the pressing part 5f is different from the pressing part 4f in that the two-surface corner membrane panel M3 side of the main body is formed in a plane. Moreover, the two-surface corner membrane anchor mechanism 5 includes a spacer 7 which is installed between the pressing part 5f and the two-surface corner membrane panel M3.

Moreover, for example, if necessary, a foamed heat insulating material is filled in a slight gap or the like which is formed between the cold insulating material layer 2d, and the plane membrane anchor mechanism 3, the three-surface corner membrane anchor mechanism 4, or the two-surface corner membrane anchor mechanism 5. In addition, if necessary, a glass cloth (not shown) or the like for securing sealing is installed at the formation position of the through-hole 6 or the like.

Subsequently, portions related to the three-surface corner membrane anchor mechanism 4 in an assembly process of the cryogenic tank 1 configured above will be described.

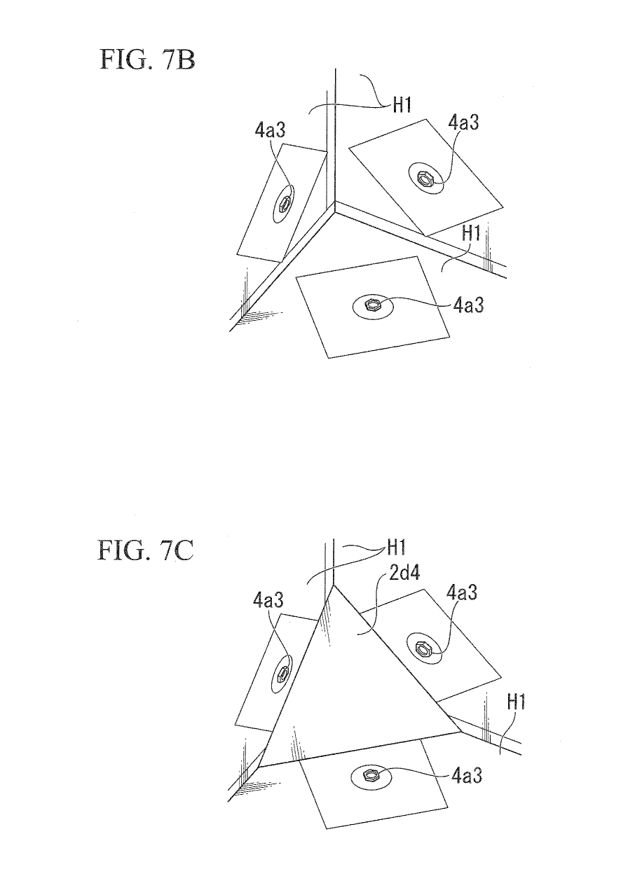

First, as shown in FIG. 7A, in a state where only the leg portions 4a of the three-surface corner membrane anchor mechanism 4 are installed, the outer layer portion 2d1 (cold insulating panel H1) of the cold insulating material layer 2d in which the through-hole, into which each leg portion 4a can be inserted, is formed is disposed.

Subsequently, a glass cloth (not shown) is stuck to the surface of the outer layer portion 2d1 of the leg portion 4a, and thereafter, as shown in FIG. 7B, the second stud bolts 4a2 of the leg portions 4a are removed. Moreover, as described above, since the length of the leg portion 4a except for the second stud bolt 4a2 is approximately the same as the thickness of the outer layer portion 2d1 of the cold insulating material layer 2d, the end portion of the long nut 4a3 is approximately flush with the surface of the outer layer portion 2d1 by removing the second stud bolt 4a2.

Subsequently, as shown in FIG. 7C, the filling portion for three-surface corner portion 2d4 is installed in a corner portion which is formed of three cold insulating panels H1. The filling portion for three-surface corner portion 2d4 has a regular triangular pyramid shape including a bottom surface on which the base portion 4b of the three-surface corner membrane anchor mechanism 4 is installed.

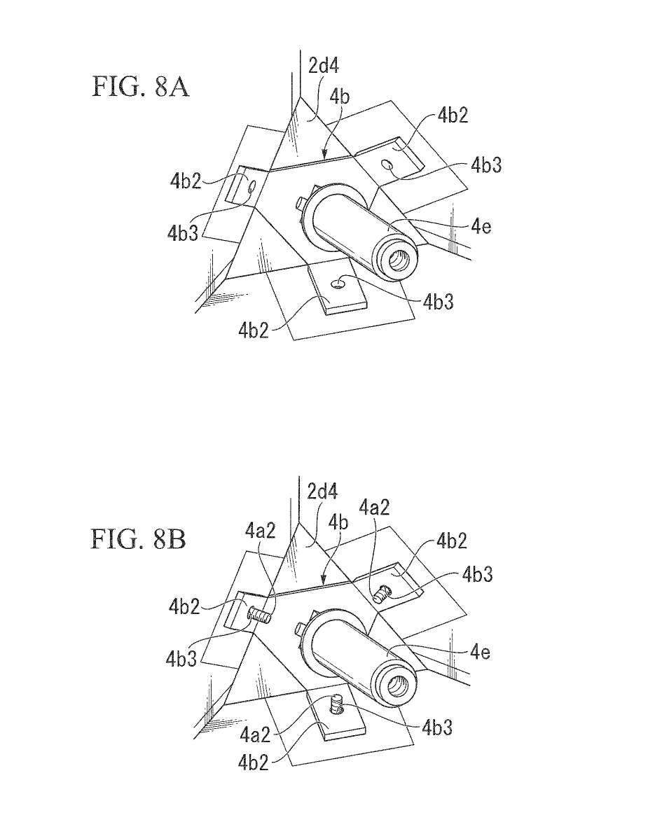

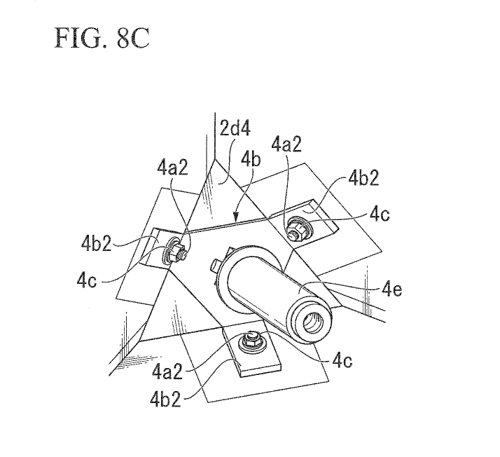

Subsequently, as shown in FIG. 8A, the base portion 4b to which the joint 4d and the anchor 4e are attached is installed. Here, the base portion 4b is installed so that the position of each of the through-holes 4b3 of the leg portion connection plates 4b2 of the base portion 4b coincides with the end portion of each of the long nuts 4a3.

Subsequently, as shown in FIG. 8B, each of the removed second stud bolts 4a2 is screwed to each of the long nuts 4a3 again from the outside of the leg portion connection plate 4b2. Moreover, as shown in FIG. 8C, the nut 4c is screwed to each of the second stud bolts 4a2 via a washer, the nut 4c is fastened so that the base portion 4b is pressed to the filling portion for three-surface corner portion 2d4, and each of the anchors 4e is fixed.

Thereafter, the glass cloth (not shown) is stuck to cover each of the leg portion connection plate 4b2, and the inner layer portion 2d2 of the cold insulating material layer 2d in which the through-hole 6, into which the anchor 4e is inserted, is formed is installed. In addition, the three-surface corner membrane panel M2 is disposed on the surface of the inner layer portion 2d2, the pressing part 4f is fixed to the anchor 4e, and the edge portion of the main body 4f1 of the pressing part 4f and the three-surface corner membrane panel M2 are welded to each other, and the three-surface corner membrane panel M2 and other membrane panels are welded to each other.

Moreover, the portions related to the two-surface corner membrane anchor mechanism 5 are assembled according to processes similar to those of three-surface corner membrane anchor mechanism 4 except that the filling portion for two-surface corner portion 2d5 having a triangular prism shape different from the filling portion for three-surface corner portion 2d4 is used, and the spacer 7 is disposed between the pressing part 5f and the two-surface corner membrane panel M3.

In the three-surface corner membrane anchor mechanism 4 of the present embodiment described above, the anchor 4e is attached to the rod-shaped leg portion 4a which is erected on the concrete wall 2a. In this way, the leg portion 4a and the anchor 4e are formed to be separated, and thus, it is possible to easily change the attachment posture of the anchor 4e with respect to the leg portion 4a. Accordingly, even when the through-hole 6 passing through the cold insulating material layer 2d and the membrane 2b is provided at any position, the attachment posture between the leg portion 4a and the anchor 4e is adopted according to a formation position of the through-hole 6, and thus, it is possible to easily dispose the anchor 4e at a position at which the anchor 4e can be inserted into the through-hole 6. The pressing part 4f is fixed to the anchor 4e which is inserted into the through-hole 6 and the membrane 2b is pressed by the pressing part 4f Therefore, according to the three-surface corner membrane anchor mechanism 4 of the present embodiment, it is possible to press an arbitrary location of the membrane 2b by arbitrarily setting the position of the through-hole 6.

Moreover, the leg portion 4a can be erected at any location of the concrete wall 2a. Accordingly, it is possible to install the three-surface corner membrane anchor mechanism 4 regardless of whether or not a haunch structure is provided on the concrete wall 2a.

Moreover, according to the three-surface corner membrane anchor mechanism 4 of the present embodiment, the anchor 4e is supported by the rod-shaped leg portion 4a, and thus, a large space is formed between the anchor 4e and the concrete wall 2a. Accordingly, it is possible to easily dispose the cold insulating panel H1 in the space, and it is possible to easily dispose the cold insulating panel H1 around the three-surface corner membrane anchor mechanism 4 without a gap.

In addition, the three-surface corner membrane anchor mechanism 4 of the present embodiment presses the three-surface corner membrane panel M2 which is curved in a spherical surface shape. In this way, even when the membrane panel is curved, the three-surface corner membrane anchor mechanism 4 of the present embodiment can press an arbitrary location.

Moreover, the three-surface corner membrane anchor mechanism 4 of the present embodiment is disposed to press the center position in the thermal deformation part of the three-surface corner membrane panel M2. Accordingly, when the three-surface corner membrane panel M2 is thermally deformed, it is possible to suppress a large amount of stress from locally acting on the three-surface corner membrane panel M2 and the three-surface corner membrane anchor mechanism 4.

In addition, the three-surface corner membrane anchor mechanism 4 of the present embodiment includes the base portion 4b to which the leg portions 4a are connected, and the joint 4d which is provided on the base portion 4b and rotatably supports the anchor 4e. Accordingly, even when the position of the anchor 4e is deviated from the through-hole 6 during the assembly, it is possible to adjust the position of the anchor 4e at the assembly site.

Moreover, in the three-surface corner membrane anchor mechanism 4 of the present embodiment, the leg portion 4a includes the stud bolts (first stud bolt 4a1 and second stud bolt 4a2) provided on both ends, and the long nut 4a3 to which the stud bolts are screwed. Accordingly, the stud bolts and the long nut 4a3 can be easily attached to and detached from each other, and thus, it is possible to easily assemble the leg portion 4a.

In addition, also in the two-surface corner membrane anchor mechanism 5 of the present embodiment, operations and effects similar to those of the three-surface corner membrane anchor mechanism 4 of the present embodiment are exerted.

While preferred embodiments of the disclosure have been described and illustrated above, it should be understood that these are exemplary of the disclosure and are not to be considered as limiting. Additions, omissions, substitutions, and other modifications can be made without departing from the spirit or scope of the present disclosure. Accordingly, the disclosure is not to be considered as being limited by the foregoing description, and is only limited by the scope of the appended claims.

According to the present disclosure, it is possible to provide a membrane anchor mechanism which can support the corner membrane panel regardless of the presence or absence of the haunch structure, can press a location which is not limited to the edge portion of the corner membrane panel, and can easily dispose the heat insulating material in the periphery.

1. A membrane anchor mechanism which fixes a membrane provided on an inner wall surface side of a concrete wall via a heating insulating material to the concrete wall in a cryogenic tank, comprising:
a rod-shaped leg portion which is erected on the concrete wall;
an anchor which is supported by the leg portion in a state of being separated from the concrete wall and is inserted into a through-hole passing through the heat insulating material and the membrane; and
a pressing part which is fixed to the anchor exposed through the through-hole and presses the membrane.

2. The membrane anchor mechanism according to claim 1,
wherein the membrane includes a corner membrane panel which is a curved membrane panel disposed at a corner portion of the cryogenic tank, and
wherein the leg portion is erected on each of a plurality of the inner wall surfaces of the concrete wall forming the corner portion, and the pressing part presses the corner membrane panel.

3. The membrane anchor mechanism according to claim 1,
wherein the pressing part is disposed to press a center position in thermal deformation part of a membrane panel forming the membrane.

4. The membrane anchor mechanism according to claim 2,
wherein the pressing part is disposed to press a center position in thermal deformation part of a membrane panel forming the membrane.

5. The membrane anchor mechanism according to claim 1, further comprising:
a base portion to which the leg portion is connected; and
a joint which is provided on the base portion and rotatably supports the anchor.

6. The membrane anchor mechanism according to claim 2, further comprising:
a base portion to which the leg portion is connected; and
a joint which is provided on the base portion and rotatably supports the anchor.

7. The membrane anchor mechanism according to claim 3, further comprising:
a base portion to which the leg portion is connected; and
a joint which is provided on the base portion and rotatably supports the anchor.

8. The membrane anchor mechanism according to claim 4, further comprising:
a base portion to which the leg portion is connected; and
a joint which is provided on the base portion and rotatably supports the anchor.

9. The membrane anchor mechanism according to claim 1,
wherein the leg portion includes stud bolts which are provided on both ends and long nuts to which the stud bolts are screwed.
